(19) United States
(12) Patent Application Publication
(10) Pub. No.: US 2024/0313877 A1
(43) Pub. Date: Sep. 19, 2024

(54) Multi-Sensor Trigger Control Method, Apparatus and Device, and Storage Medium

(71) Applicant: SHENZHEN AUTOMOTIVE RESEARCH INSTITUTE, BEIJING INSTITUTE OF TECHNOLOGY (SHENZH, Shenzhen (CN)

(72) Inventors: Chao Sun, Shenzhen (CN); Guodong Yang, Shenzhen (CN); Bing Lu, Shenzhen (CN); Bo Wang, Shenzhen (CN); Shijia Song, Shenzhen (CN); Chunxia Zhang, Shenzhen (CN); Wenyi Huang, Shenzhen (CN); Wenwei Wang, Shenzhen (CN)

(21) Appl. No.: 18/671,150

(22) Filed: May 22, 2024

Related U.S. Application Data
(63) Continuation of application No. PCT/CN2023/132664, filed on Nov. 20, 2023.

(30) Foreign Application Priority Data
Nov. 24, 2022 (CN) 202211482831.8

(51) Int. Cl. H04J 3/06; H04L 67/12

(52) U.S. Cl. CPC H04J 3/0638; H04L 67/12

(57) ABSTRACT

Embodiments of the present application disclose a multi-sensor trigger control method, apparatus and device, and a storage medium, and relate to the technical field of sensors. The method includes: acquiring a target output frequency and an output phase set; determining, according to the output phase set and a preset value, an initial value and an overflow value of a counter corresponding to each phase in the output phase set; calculating a reference frequency according to the overflow value and the target output frequency; detecting, according to a received input signal and an output signal corresponding to the reference frequency, whether a phase alignment condition is met; and if the phase alignment condition is met, performing multi-sensor trigger through a trigger control method according to the overflow value and the initial value. By means of the embodiments of the present application, the trigger moment can be flexibly adjusted.

### CROSS REFERENCE TO RELATED APPLICATIONS

The present application is a Continuation Application of PCT Application No. PCT/CN2023/132664 filed on Nov. 20, 2023, which is based on and claims priority to the Chinese Patent Application No. 202211482831.8, filed on Nov. 24, 2022, the entire contents of which are incorporated herein by reference.

### TECHNICAL FIELD

The present application relates to the technical field of sensors, in particular to a multi-sensor trigger control method, apparatus and device, and a storage medium.

### BACKGROUND ART

With the development of autonomous driving technology, the number of sensors is exploding, and in order to achieve accurate environmental perception, the sensors must rely on high-precision time synchronization trigger devices. For example, in a high-speed driving scenario of 100 km/h, a delay of 0.1 s between a lidar and a camera will introduce a position error of 2.78 meters; or in SLAM applications, the time unsynchronization between an IMU and the lidar may cause a system to fail to work properly. However, a trigger method in the prior art is unable to flexibly the trigger moment in the test process because of synchronous triggering at a fixed frequency.

### SUMMARY OF THE INVENTION

Embodiments of the present application provide a multi-sensor trigger control method, apparatus and device, and a storage medium, aiming to solve the problem that the trigger moment cannot be flexibly adjusted in the prior art.

In a first aspect, an embodiment of the present application provides a multi-sensor trigger control method. The method includes:
acquiring a target output frequency and an output phase set;
determining, according to the output phase set and a preset value, an initial value and an overflow value of a counter corresponding to each phase in the output phase set;
calculating a reference frequency according to the overflow value and the target output frequency;
detecting, according to a received input signal and an output signal corresponding to the reference frequency, whether a phase alignment condition is met; and
if the phase alignment condition is met, performing multi-sensor trigger through a trigger control method according to the overflow value and the initial value.

In a second aspect, an embodiment of the present application further provides a multi-sensor trigger control apparatus. The apparatus includes:
an acquiring unit, configured to acquire a target output frequency and an output phase set;
a determining unit, configured to determine, according to the output phase set and a preset value, an initial value and an overflow value of a counter corresponding to each phase in the output phase set;
a calculation unit, configured to calculate a reference frequency according to the overflow value and the target output frequency;
a detection unit, configured to detect, according to a received input signal and an output signal corresponding to the reference frequency, whether a phase alignment condition is met; and
a trigger unit, configured to perform, if the phase alignment condition is met, multi-sensor trigger through a trigger control method according to the overflow value and the initial value.

In a third aspect, an embodiment of the present application further provides a multi-sensor trigger control device. The multi-sensor trigger control device includes a control module, the control module includes a memory and a processor, the memory has a computer program stored thereon, and the processor, when executing the computer program, implements the method described above.

In a fourth aspect, an embodiment of the present application further provides a computer-readable storage medium. The computer-readable storage medium has a computer program stored thereon, and the computer program, when executed by a processor, implements the method described above.

The embodiments of the present application provide the multi-sensor trigger control method, apparatus and device, and the storage medium. The method includes: acquiring the target output frequency and the output phase set; determining, according to the output phase set and the preset value, the initial value and the overflow value of the counter corresponding to each phase in the output phase set; calculating the reference frequency according to the overflow value and the target output frequency; detecting, according to the received input signal and the output signal corresponding to the reference frequency, whether the phase alignment condition is met; and if the phase alignment condition is met, performing multi-sensor trigger through the trigger control method according to the overflow value and the initial value. In the technical solutions of the embodiments of the present application, the initial value and the overflow value of the counter are first determined according to the output phase set and the preset value, and multi-sensor trigger is controlled by means of the trigger control method according to the overflow value and the initial value, which facilitates the adjustment of the phases, and then the trigger moment may be flexibly adjusted.

### BRIEF DESCRIPTION OF THE DRAWINGS

In order to explain the technical solutions in the embodiments of the present application more clearly, the drawings that need to be used in the description of the embodiments will be briefly described below. Apparently, the drawings in the following description illustrate some embodiments of the present application, and a person of ordinary skill in the art may also derive other drawings based on the drawings described herein without any creative effort.

FIG. 1 is a schematic diagram of multi-sensor trigger control according to an embodiment of the present application;

FIG. 2 is a schematic flow diagram of a multi-sensor trigger control method according to an embodiment of the present application;

FIG. 3 is a schematic sub-flow diagram of a multi-sensor trigger control method according to an embodiment of the present application;

FIG. 4 is a schematic scene diagram of a multi-sensor trigger control method according to an embodiment of the present application;

FIG. 5 is a trigger timing diagram of multi-sensor trigger control in FIG. 4; and

FIG. 6 is a schematic block diagram of a multi-sensor trigger control device according to an embodiment of the present application.

### DETAILED DESCRIPTION OF THE INVENTION

The technical solutions of the embodiments of the present application will be clearly and completely described below with reference to the accompanying drawings of the embodiments of the present application. Apparently, the embodiments described are a part of the embodiments of the present application, rather than all of the embodiments. Based on the embodiments of the present application, all other embodiments obtained by a person of ordinary skill in the art without any creative effort fall within the scope of protection of the present application.

It is to be understood that, when used in this specification and the appended claims, the terms “include” and “have” indicate the presence of the described features, wholes, steps, operations, elements and/or components, but do not exclude the presence or addition of one or more other features, wholes, steps, operations, elements, components and/or collections thereof.

It is also to be understood that the terms as used in the specification of the present application are used merely for the purpose of describing particular embodiments and are not intended to limit the present application. As used in the specification and the appended claims of the present application, the singular forms “a”, “one” and “the” are intended to include the plural form unless the context clearly indicates otherwise.

It is to be further understood that the term “and/or” as used in the specification and the appended claims of the present application refers to and includes any combination and all possible combinations of one or more of the items listed in association.

As used in this specification and the appended claims, the term “if” may be interpreted contextually as “when” or “once” or “in response to determining” or “in response to detecting”. Similarly, the phrases “if determining” or “if detecting [the described condition or event]” may be interpreted contextually to mean “once determining” or “in response to determining” or “once detecting [the described condition or event]” or “in response to detecting [the described condition or event]”.

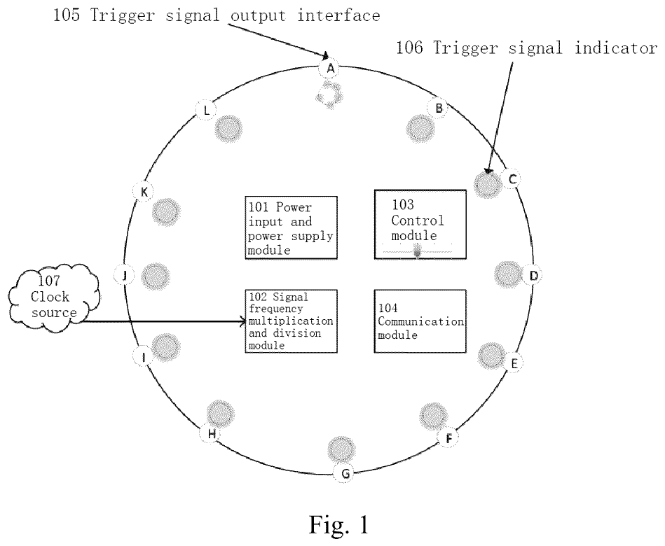

Referring to FIG. 1, FIG. 1 is a schematic diagram of multi-sensor trigger control according to an embodiment of the present application. The multi-sensor trigger control method of an embodiment of the present application may be applied in a multi-sensor trigger control device, for example, the multi-sensor trigger control method may be realized by a software program configured to correspond to the multi-sensor trigger control device, so as to realize flexible adjustment of the trigger moment. As shown in FIG. 1, the multi-sensor trigger control device includes a control module 103, a communication module 104, an output module, an indication module, a signal frequency multiplication and division module 102, and a power input and power supply module 101. Specifically, the output module includes a plurality of trigger signal output interfaces 105, the indication module includes a plurality of trigger signal indicators 106, and the plurality of trigger signal indicators 106 correspond to the plurality of trigger signal output interfaces 105; the control module 103 is connected to the signal frequency multiplication and division module 102, the output module and the indication module; the communication module 104 is configured to be connected to an upper computer; the output module is configured to receive a trigger signal sent by the control module 103; and the power input and power supply module 101 is configured to supply power to the multi-sensor trigger control device, and includes an external power interface and a voltage stabilizing module. More specifically, the control module 103 includes a plurality of counters, a plurality of comparators and a plurality of signal amplifiers corresponding to the plurality of trigger signal output interfaces 105. The signal frequency multiplication and division module 102 is connected to the counters, the counters are connected to the comparators, the comparators are connected to the signal amplifiers, and the signal amplifiers are connected to the trigger signal output interfaces 105.

It is to be noted that in the embodiments of the present application, the signal frequency multiplication and division module 102 includes an analog/digital frequency multiplication circuit or a frequency division circuit which may adjust the frequency corresponding to the input signal to a target output frequency within a certain range. Specifically, frequency multiplication may be realized by a phase-locked loop (PLL) or a gate delay, and frequency division may be realized by counter setting. The communication module 104 may communicate with other devices, such as an upper computer, to realize the report of timestamps; in practice, the communication module 104 appends fixed-length timestamp data in binary form to the front end of data collected by a sensor and sends the data to the upper computer. The report method is suitable for sensor devices with a relatively high data frequency and a small amount of data in a single pass, such as IMUs, with a typical frequency of 100 Hz. The communication module may also directly send the acquired timestamp data to the upper computer, which carries out the binding of the collected data and timestamps. This method is suitable for sensor devices with a relatively low data frequency, such as cameras, with a typical frequency of 10 Hz. The plurality of signal trigger indicators are all LED indicators. It is also to be noted that in the embodiments of the present application, the input signal is a clock source 107; the plurality of trigger signal output interfaces 105 are set in a ring shape, accordingly, the plurality of trigger signal indicators 106 are also set in a ring shape, and the control module 103, the communication module 104, the power input and power supply module 101 and the signal frequency multiplication and division module 102 are all provided in the ring. The plurality of trigger signal output interfaces 105 and the plurality of sensors are hard trigger which is level trigger.

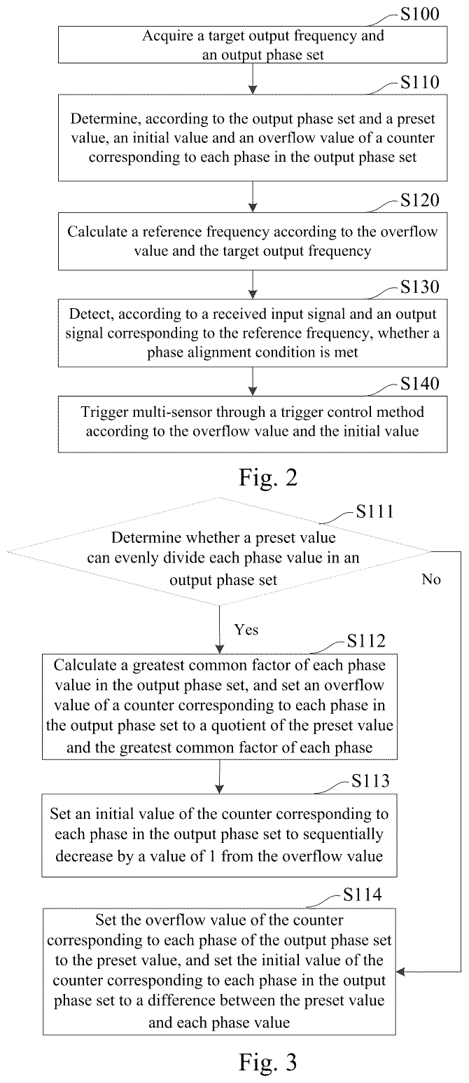

Referring to FIG. 2, FIG. 2 is a schematic flow diagram of a multi-sensor trigger control method according to an embodiment of the present application. As shown in FIG. 2, the method includes the following steps S100-S140.

S100, acquire a target output frequency and an output phase set.

In the embodiment of the present application, a user first sets, via the upper computer, the target frequency and the output phase set to be outputted by the control module, wherein the number of phases in the output phase set corresponds to the number of the plurality of trigger signal output interfaces. As shown in FIG. 1, in this embodiment, the output module includes twelve interfaces, which are an interface A, an interface B, an interface C, an interface D, an interface E, an interface F, an interface G, an interface H, an interface I, an interface J, an interface K, and an interface L, and it is understood that the output phase set includes twelve phases. After the setting is completed, the control module may acquire the target output frequency and the output phase set for use in subsequent steps.

S110, determine, according to the output phase set and a preset value, an initial value and an overflow value of a counter corresponding to each phase in the output phase set.

In the embodiment of the present application, after acquiring the target output frequency and the output phase set, the control module may determine, according to the output phase set and the preset value, the initial value and the overflow value of the counter corresponding to each phase in the output phase set, and the preset value is 360. It is to be noted that in this embodiment, determining the initial value and the overflow value of the counter corresponding to each phase in the output phase set is to determine an initial value and an overflow value of a counter corresponding to each of the plurality of trigger signal output interfaces, i.e., the plurality of trigger signal output interfaces correspond to the plurality of phases in the output phase set.

Referring to FIG. 3, in one embodiment, for example, in an embodiment of the present application, step S110 includes steps S111-S114 as follows.

S111, determine whether the preset value can evenly divide each phase value in the output phase set. If the preset value can evenly divide each phase value in the output phase set, step S112 is performed, otherwise step S114 is performed.

S112, calculate a greatest common factor of each phase value in the output phase set, and set the overflow value of the counter corresponding to each phase in the output phase set to a quotient of the preset value and the greatest common factor of each phase.

S113, set the initial value of the counter corresponding to each phase in the output phase set to sequentially decrease by a value of 1 from the overflow value.

S114, set the overflow value of the counter corresponding to each phase in the output phase set to the preset value, and set the initial value of the counter corresponding to each phase in the output phase set to a difference between the preset value and each phase value.

S120, calculate a reference frequency on the basis of the overflow value and the target output frequency.

In an embodiment of the present application, after the overflow value is calculated, the reference frequency is calculated on the basis of the overflow value and the target output frequency. Specifically, the reference frequency is obtained by calculating a product of the target output frequency and the overflow value. For example, assuming that the frequency of the clock source signal is 1 HZ, a frequency multiplier in the signal frequency multiplication and division module is 10, the target output frequency is 10 HZ, and the overflow value is 360, the reference frequency is 3600 HZ. It is to be noted that in this embodiment, the reason why the reference frequency is the product of the target output frequency and the overflow value is that it is triggered once every time the overflow value of the counter is reached, which is equivalent to obtaining the target output frequency with 3600/360=10 Hz to be provided to the sensor.

S130, detect, according to a received input signal and an output signal corresponding to the reference frequency, whether a phase alignment condition is met.

In an embodiment of the present application, after the reference frequency is calculated, if an input signal is received, that is, if the clock source signal is received, whether the number of times of alignment is a preset number of times of alignment, and the preset number of times of alignment is 0. If the number of times of alignment is the preset number of times of alignment, a preset phase of the input signal is aligned with a preset phase of the output signal corresponding to the reference frequency, and the preset phase is a phase 0, that is, the phase 0 of the input signal is aligned with the phase 0 of the output signal. If the number of times of alignment is not the preset number of times of alignment, it is indicated that the phase 0 of the input signal has been aligned with the phase 0 of the output signal, thereby determining that the phase alignment condition is met.

S140, if the phase alignment condition is met, perform multi-sensor trigger through a trigger control method according to the overflow value and the initial value.

In an embodiment of the present application, when the phase alignment condition is met, multi-sensor trigger is performed through the trigger control method according to the overflow value and the initial value of each interface counter for data acquisition. Specifically, the output signals are counted through the counter on the basis of the initial value of each interface counter so as to update the initial value; when the updated initial value reaches the overflow value, the control module sends a trigger signal to a sensor corresponding to the initial value to trigger the sensor; and the initial value is set to a preset value, the preset value is 0, and the step of counting the output signals through the counter on the basis of the initial value so as to update the initial value is performed again until a preset trigger stop instruction is received. For example, assuming that the overflow value of the counter of each interface is 360, and the initial values of the counters of each interface (the interface A, the interface B, the interface C, the interface D, the interface E, the interface F, the interface G, the interface H, the interface I, the interface J, the interface K, and the interface L) are 360, 350, 349, 345, 240, 210, 180, 150, 120, 90, 60, and 30, respectively. After the counting starts, the interface A starts counting from 360, the interface B starts counting from 350, the interface C starts counting from 349, and so on, and the interface L starts counting from 30. It can be understood that the interface A reaches the overflow value at the beginning of work of the algorithm, and afterwards, the control module sends a trigger signal to a trigger device connected to the interface A so as to trigger the sensor to perform data acquisition, and the initial value of the counter of the interface A is set to 0; and counting continues, the interface A starts counting from 0 at this time, then the initial value of the interface B will reach the overflow value of 360, the control module may send a trigger signal to a sensor connected to the interface B to trigger the sensor to perform data acquisition, the initial value of the counter of the interface B is set to 0, and so on, until the preset trigger stop instruction is received.

Further, after the initial value of the counter of each interface reaches the overflow value, the control module, in addition to sending the trigger signal to the sensor, may also send an indication signal to the corresponding indicator to light up the indicator to characterize that the interface is working. It is to be understood that when the control module sends the trigger signal to the sensor, the control module may send an acquisition instruction to a communication module, and the communication module acquires a current timestamp on the basis of the acquiring instruction and sends the timestamp to an upper computer for the upper computer to record the time when the sensor collects data.

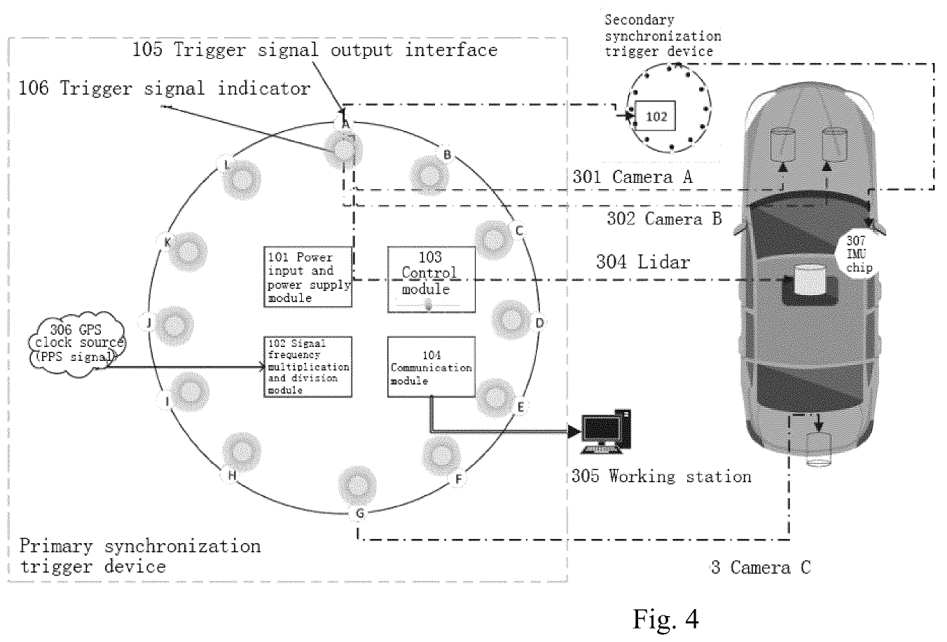

Referring to FIG. 4, FIG. 4 is a schematic scene diagram of multi-sensor trigger control according to embodiments of the present application. FIG. 4 includes a primary synchronization trigger and a secondary synchronization trigger. An input of the signal frequency multiplication and division module 102 in the primary synchronization trigger is a GPS clock source signal 306. The camera A301, the camera B302 and the lidar 304 are connected to the trigger signal output interface A105, and the camera C303 is connected to the trigger signal output interface G. The communication module 104 is connected to the workstation 305, which can set the frequency multiplication of the communication module 104 to 10, that is, the output frequency of the output interface is converted from 1 Hz of the GPS clock signal 306 to 10 Hz, and an output of the trigger signal output interface A105 is set to be asynchronous, with a phase delay of 30°. The input of the signal frequency multiplication and division module 102 in the secondary synchronization trigger is connected to the trigger signal output interface A105 of the primary synchronization trigger, and the frequency multiplication of the communication module 104 of the secondary synchronization trigger is set to 20, that is, the output frequency of the trigger signal output interface is converted from 10 Hz of the primary synchronization trigger to 200 Hz, that is, the effect of cascading is achieved, and the output frequency may be changed. It can be understood that in the application scenario of FIG. 4, the camera A301, the camera B302, the camera C303, and the lidar 304 may all be collectively referred to as sensors. It is to be noted that when the trigger signal output interfaces A105 are triggered, the trigger signal indicators 106 may be illuminated.

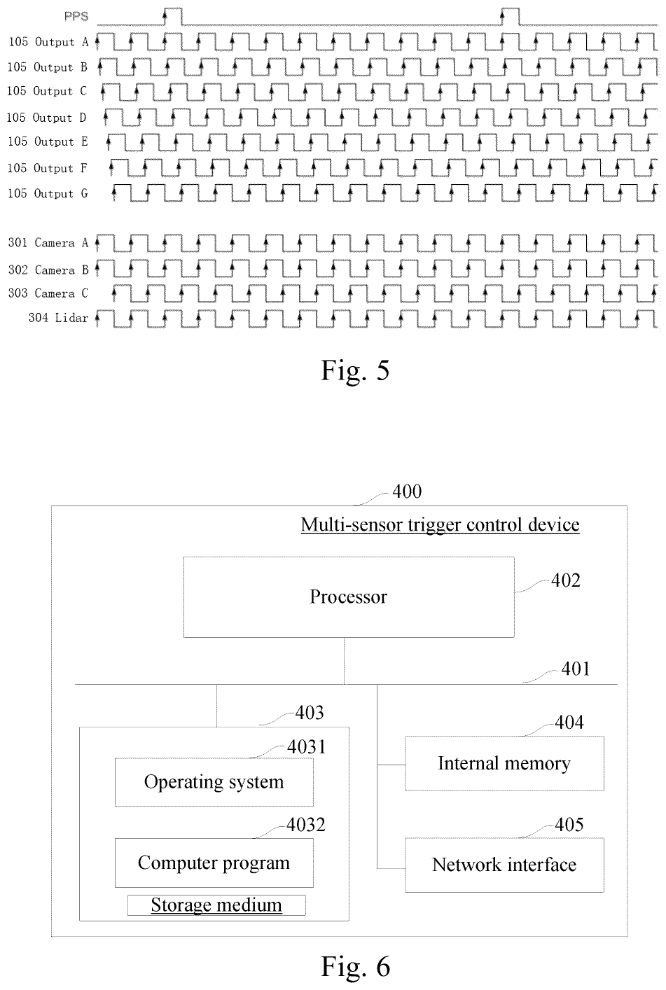

Referring to FIG. 5, FIG. 5 is a trigger timing diagram of multi-sensor trigger control in FIG. 4. In FIG. 5, PPS is a GPS clock source signal, and the camera A301, the camera B302, and the lidar 304 are triggered in the same phase to simultaneously collect images in front of a vehicle; and the camera C303 is triggered with a delayed phase of 180° compared to the lidar 304, and at this time, the lidar is rotated to the rear of the vehicle so as to coincide with the field of view of the camera C303.

The above multi-sensor triggering control apparatus may be implemented in the form of a computer program that may run on a multi-sensor trigger control device as shown in FIG. 6.

Referring to FIG. 6, FIG. 6 is a schematic block diagram of a multi-sensor trigger control device according to an embodiment of the present application. The multi-sensor trigger control device 400 includes a control module.

Referring to FIG. 6, the multi-sensor trigger control device 400 includes a processor 402, a memory, and a network interface 405 which are connected via a system bus 401. The memory may include a storage medium 403 and an internal memory 404.

The storage medium 403 may store an operating system 4031 and a computer program 4032. The computer program 4032, when executed, may cause the processor 402 to perform a multi-sensor trigger control method.

The processor 402 is used to provide calculation and control capabilities to support the operation of the entire multi-sensor trigger control device 400.

The internal memory 404 provides an environment for the operation of the computer program 4032 in the storage medium 403, and the computer program 4032, when executed by the processor 402, may cause the processor 402 to perform a multi-sensor trigger control method.

The network interface 405 is used for network communication with other devices. It will be understood by those skilled in the art that the structure illustrated in FIG. 6, which is only a block diagram of a portion of the structure related to the solutions of the present application, does not constitute a limitation on the multi-sensor trigger control device 400 to which the solutions of the present application are applied, specifically, the multi-sensor trigger control device 400 may include more or fewer components than those shown in the drawings or a combination of some of the components, or have a different arrangement of components.

The processor 402 is used to run a computer program 4032 stored in the memory to implement any embodiment of the multi-sensor trigger control method described above.

It should be understood that in the embodiments of the present application, the processor 402 may be a central processing unit (CPU), which may also be another general purpose processor, a digital signal processor (DSP), an application specific integrated circuit (ASIC), a field-programmable gate array (FPGA) or other programmable logic devices, a discrete gate or transistor logic device, a discrete hardware component, and the like. The general purpose processor may be a microprocessor or the processor may also be any conventional processor, etc.

It will be appreciated by a person of ordinary skill in the art that implementing all or part of the process in the method of the above embodiments may be completed by instructing the relevant hardware by a computer program. The computer program may be stored in a storage medium which is a computer-readable storage medium. The computer program is executed by at least one processor in the computer system to implement the process steps of the embodiments of the method described above.

Accordingly, the present application further provides a storage medium. The storage medium may be a computer-readable storage medium. The storage medium has a computer program stored thereon. The computer program, when executed by a processor, causes the processor to execute any embodiment of the multi-sensor trigger control method described above.

The storage medium may be a USB flash drive, a removable hard disk, a read-only memory (ROM), a diskette, or a compact disc, and other computer-readable storage media that can store program codes

A person of ordinary skill in the art may realize that the units and algorithmic steps of the various examples described in conjunction with the embodiments disclosed herein are capable of being implemented in electronic hardware, computer software, or a combination of both, and that the composition and steps of the various examples have been described in the foregoing description in general terms according to functionality in order to clearly illustrate the interchangeability of the hardware and the software. Whether to implement such functionality with hardware or software depends upon the particular application of the technical solutions and constraint conditions of the design. A skilled person may implement the described functionality in varying ways for each particular application, but such implementation should not be interpreted as causing a departure from the scope of the present application.

In the several embodiments provided in the present application, it should be understood that the apparatuses and methods disclosed may be realized in other ways. For example, the apparatus embodiments described above are merely schematic. For example, the division of each unit is only a logical functional division, and there may be other ways of division during actual implementation. For example, multiple units or components may be combined or may be integrated into another system, or some features may be ignored, or not implemented.

The steps in the methods of the embodiments of the present application may be reordered, combined, and deleted according to actual needs. The units in the apparatus of the embodiments of the present application may be combined, divided, and deleted according to actual needs. In addition, the functional units in the various embodiments of the present application may be integrated in a single processing unit, or each unit may physically exist separately, or two or more units may be integrated in a single unit.

The integrated unit, if implemented as a software functional unit and sold or used as a stand-alone product, may be stored in a storage medium. With this understanding, the technical solutions of the present application in essence or a portion contributing to the prior art, or all or a portion of the technical solutions may be embodied in the form of a software product, and the computer software product is stored in a storage medium which includes a plurality of instructions used to cause a multi-sensor trigger control device (which may be a personal computer, a terminal, a networked device, or the like) to perform all or a portion of the steps of the method described in each embodiment of the present application.

In the foregoing embodiments, each embodiment is described in its own way, and portions that are not described in detail in one embodiment can be found in the descriptions of other embodiments.

Apparently, those skilled in the art can make various modifications and variations to the present application without departing from the spirit and scope of the present application. Thus, to the extent that such modifications and variations of the present application fall within the scope of the claims of the present application and their technical equivalents, the present application is also intended to include such modifications and variations.

The foregoing is only specific implementations of the present application, but the scope of protection of the present application is not limited thereto, and any person skilled in the art can readily think of various equivalent modifications or substitutions within the scope of the technology disclosed in the present application, which should fall within the scope of protection of the present application. Therefore, the scope of protection of the present application shall be based on the scope of protection of the claims.

What is claimed is:

1. A multi-sensor trigger control method, comprising:
acquiring a target output frequency and an output phase set;
determining, according to the output phase set and a preset value, an initial value and an overflow value of a counter corresponding to each phase in the output phase set;
calculating a reference frequency according to the overflow value and the target output frequency;
detecting, according to a received input signal and an output signal corresponding to the reference frequency, whether a phase alignment condition is met; and
if the phase alignment condition is met, performing multi-sensor trigger through a trigger control method according to the overflow value and the initial value,
wherein the step of determining, according to the output phase set and a preset value, an initial value and an overflow value of a counter corresponding to each phase in the output phase set comprises:
determining whether the preset value can evenly divide each phase value in the output phase set;
if the preset value can evenly divide each phase value in the output phase set, calculating a greatest common factor of each phase value in the output phase set, and setting the overflow value of the counter corresponding to each phase in the output phase set to a quotient of the preset value and the greatest common factor of each phase; and
setting the initial value of the counter corresponding to each phase in the output phase set to sequentially decrease by a value of 1 from the overflow value.

2. The method according to claim 1, wherein after the step of determining whether the preset value is capable of evenly dividing each phase value in the output phase set, the method further comprises:
if the preset value cannot evenly divide each phase value in the output phase set, setting the overflow value of the counter corresponding to each phase in the output phase set to the preset value; and
setting the initial value of the counter corresponding to each phase in the output phase set to a difference between the preset value and each phase value.

3. The method according to claim 1, wherein the step of detecting, according to a received input signal and an output signal corresponding to the reference frequency, whether a phase alignment condition is met comprises:
if the input signal is received, detecting whether the number of times of alignment is a preset number of times of alignment;
if the number of times of alignment is the preset number of times of alignment, aligning a preset phase of the input signal with a preset phase of the output signal corresponding to the reference frequency; and
if the number of times of alignment is not the preset number of times of alignment, determining that the phase alignment condition is met.

4. The method according to claim 1, wherein the step of performing multi-sensor trigger through a trigger control method according to the overflow value and the initial value comprises:
counting, on the basis of the initial value, the output signals through the counter to update the initial value;
if the updated initial value reaches the overflow value, sending a trigger signal to a sensor corresponding to the initial value to trigger the sensor; and
setting the initial value to a preset value and returning to perform the step of counting, on the basis of the initial value, the output signals through the counter to update the initial value until receiving a preset trigger stop instruction.

5. The method according to claim 1, further comprising:
if a trigger signal is detected, acquiring a current timestamp, and sending the timestamp to an upper computer.

6. A multi-sensor trigger control device, comprising a control module, the control module comprising a memory and a processor, the memory having a computer program stored thereon, the processor is used for executing the computer programs to perform the steps of:
acquiring a target output frequency and an output phase set;
determining, according to the output phase set and a preset value, an initial value and an overflow value of a counter corresponding to each phase in the output phase set;
calculating a reference frequency according to the overflow value and the target output frequency;
detecting, according to a received input signal and an output signal corresponding to the reference frequency, whether a phase alignment condition is met; and
if the phase alignment condition is met, performing multi-sensor trigger through a trigger control method according to the overflow value and the initial value,
wherein the step of determining, according to the output phase set and a preset value, an initial value and an overflow value of a counter corresponding to each phase in the output phase set comprises:
determining whether the preset value can evenly divide each phase value in the output phase set;
if the preset value can evenly divide each phase value in the output phase set, calculating a greatest common factor of each phase value in the output phase set, and setting the overflow value of the counter corresponding to each phase in the output phase set to a quotient of the preset value and the greatest common factor of each phase; and
setting the initial value of the counter corresponding to each phase in the output phase set to sequentially decrease by a value of 1 from the overflow value.

7. The multi-sensor trigger control device according to claim 6, wherein after the step of determining whether the preset value is capable of evenly dividing each phase value in the output phase set, the method further comprises:
if the preset value cannot evenly divide each phase value in the output phase set, setting the overflow value of the counter corresponding to each phase in the output phase set to the preset value; and
setting the initial value of the counter corresponding to each phase in the output phase set to a difference between the preset value and each phase value.

8. The multi-sensor trigger control device according to claim 6, wherein the step of detecting, according to a received input signal and an output signal corresponding to the reference frequency, whether a phase alignment condition is met comprises:
if the input signal is received, detecting whether the number of times of alignment is a preset number of times of alignment;
if the number of times of alignment is the preset number of times of alignment, aligning a preset phase of the input signal with a preset phase of the output signal corresponding to the reference frequency; and
if the number of times of alignment is not the preset number of times of alignment, determining that the phase alignment condition is met.

9. The multi-sensor trigger control device according to claim 6, wherein the step of performing multi-sensor trigger through a trigger control method according to the overflow value and the initial value comprises:
counting, on the basis of the initial value, the output signals through the counter to update the initial value;
if the updated initial value reaches the overflow value, sending a trigger signal to a sensor corresponding to the initial value to trigger the sensor; and
setting the initial value to a preset value and returning to perform the step of counting, on the basis of the initial value, the output signals through the counter to update the initial value until receiving a preset trigger stop instruction.

10. The multi-sensor trigger control device according to claim 6, further comprising:
if a trigger signal is detected, acquiring a current timestamp, and sending the timestamp to an upper computer.

11. The multi-sensor trigger control device according to claim 6, further comprising a signal frequency multiplication and division module, a communication module, an output module, an indication module, and a power input and power supply module, wherein the output module comprises a plurality of trigger signal output interfaces, the indication module comprises a plurality of trigger signal indicators, the plurality of trigger signal indicators correspond to the plurality of trigger signal output interfaces, the control module is connected to the signal frequency multiplication and division module, the output module and the indication module, the communication module is configured to be connected to an upper computer, and the output module is configured to receive a trigger signal sent by the control module.

12. The multi-sensor trigger control device according to claim 7, further comprising a signal frequency multiplication and division module, a communication module, an output module, an indication module, and a power input and power supply module, wherein the output module comprises a plurality of trigger signal output interfaces, the indication module comprises a plurality of trigger signal indicators, the plurality of trigger signal indicators correspond to the plurality of trigger signal output interfaces, the control module is connected to the signal frequency multiplication and division module, the output module and the indication module, the communication module is configured to be connected to an upper computer, and the output module is configured to receive a trigger signal sent by the control module.

13. The multi-sensor trigger control device according to claim 8, further comprising a signal frequency multiplication and division module, a communication module, an output module, an indication module, and a power input and power supply module, wherein the output module comprises a plurality of trigger signal output interfaces, the indication module comprises a plurality of trigger signal indicators, the plurality of trigger signal indicators correspond to the plurality of trigger signal output interfaces, the control module is connected to the signal frequency multiplication and division module, the output module and the indication module, the communication module is configured to be connected to an upper computer, and the output module is configured to receive a trigger signal sent by the control module.

14. The multi-sensor trigger control device according to claim 9, further comprising a signal frequency multiplication and division module, a communication module, an output module, an indication module, and a power input and power supply module, wherein the output module comprises a plurality of trigger signal output interfaces, the indication module comprises a plurality of trigger signal indicators, the plurality of trigger signal indicators correspond to the plurality of trigger signal output interfaces, the control module is connected to the signal frequency multiplication and division module, the output module and the indication module, the communication module is configured to be connected to an upper computer, and the output module is configured to receive a trigger signal sent by the control module.

15. The multi-sensor trigger control device according to claim 10, further comprising a signal frequency multiplication and division module, a communication module, an output module, an indication module, and a power input and power supply module, wherein the output module comprises a plurality of trigger signal output interfaces, the indication module comprises a plurality of trigger signal indicators, the plurality of trigger signal indicators correspond to the plurality of trigger signal output interfaces, the control module is connected to the signal frequency multiplication and division module, the output module and the indication module, the communication module is configured to be connected to an upper computer, and the output module is configured to receive a trigger signal sent by the control module.

16. A computer readable storage medium, wherein the storage medium stores a computer program, and the computer program, when executed by a processor, implements the steps of:
acquiring a target output frequency and an output phase set;
determining, according to the output phase set and a preset value, an initial value and an overflow value of a counter corresponding to each phase in the output phase set;
calculating a reference frequency according to the overflow value and the target output frequency;
detecting, according to a received input signal and an output signal corresponding to the reference frequency, whether a phase alignment condition is met; and
if the phase alignment condition is met, performing multi-sensor trigger through a trigger control method according to the overflow value and the initial value,
wherein the step of determining, according to the output phase set and a preset value, an initial value and an overflow value of a counter corresponding to each phase in the output phase set comprises:
determining whether the preset value can evenly divide each phase value in the output phase set;
if the preset value can evenly divide each phase value in the output phase set, calculating a greatest common factor of each phase value in the output phase set, and setting the overflow value of the counter corresponding to each phase in the output phase set to a quotient of the preset value and the greatest common factor of each phase; and
setting the initial value of the counter corresponding to each phase in the output phase set to sequentially decrease by a value of 1 from the overflow value.

17. The computer readable storage medium according to claim 16, wherein after the step of determining whether the preset value is capable of evenly dividing each phase value in the output phase set, the method further comprises:
if the preset value cannot evenly divide each phase value in the output phase set, setting the overflow value of the counter corresponding to each phase in the output phase set to the preset value; and
setting the initial value of the counter corresponding to each phase in the output phase set to a difference between the preset value and each phase value.

18. The computer readable storage medium according to claim 16, wherein the step of detecting, according to a received input signal and an output signal corresponding to the reference frequency, whether a phase alignment condition is met comprises:
if the input signal is received, detecting whether the number of times of alignment is a preset number of times of alignment;
if the number of times of alignment is the preset number of times of alignment, aligning a preset phase of the input signal with a preset phase of the output signal corresponding to the reference frequency; and
if the number of times of alignment is not the preset number of times of alignment, determining that the phase alignment condition is met.

19. The computer readable storage medium according to claim 16, wherein the step of performing multi-sensor trigger through a trigger control method according to the overflow value and the initial value comprises:
counting, on the basis of the initial value, the output signals through the counter to update the initial value;
if the updated initial value reaches the overflow value, sending a trigger signal to a sensor corresponding to the initial value to trigger the sensor; and
setting the initial value to a preset value and returning to perform the step of counting, on the basis of the initial value, the output signals through the counter to update the initial value until receiving a preset trigger stop instruction.

20. The computer readable storage medium according to claim 16, further comprising:
if a trigger signal is detected, acquiring a current timestamp, and sending the timestamp to an upper computer.
